(19) United States
(12) Patent Application Publication
(10) Pub. No.: US 2006/0080231 A1
(43) Pub. Date: Apr. 13, 2006

(54) Credit sales method and system

(75) Inventor: Takuji Numata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/041,247

(22) Filed: Jan. 25, 2005

(30) Foreign Application Priority Data
Sep. 27, 2004 (JP) 2004-280499

(51) Int. Cl. G06Q 40/00

(52) U.S. Cl. 705/39

(57) ABSTRACT

A system determines whether purchase history information of a customer satisfies a credit balance increment condition with reference to a first storage that stores the purchase history information of the customer. If the purchase history information satisfies the credit balance increment condition, the member store calculates a credit balance increment rate on its own risk. The member store approves a payment by the credit card when the requested payment price is lower than the product of the credit balance by the credit balance increment rate even if the requested payment price is higher than the credit balance.

### BACKGROUND OF THE INVENTION

The present invention relates to a credit sales method and system thereof to control a sale of a commodity or service at a member store using a credit card. Particularly, the present invention relates to method and system to control a credit balance for each customer.

A credit sale using a credit card is usually limited by a credit limit established by a credit sales company. However, if the credit limit is strictly fixed, a member store may miss a sales chance. Thus, Japanese unexamined patent publication No. 124591/1998 discloses the system that permits a credit sale whose purchase price is higher than the credit limit when a member store accepts the dealing.

With the system disclosed in the publication, when a settlement finishes without any problems, since the customer's request to buy a commodity is satisfied and the sales of the member store and the credit sales company increase, merits of three parties are agreed. However, if a customer will be insolvent, since the credit sales company must bear the loss alone even for the amount beyond the credit limit, the loss of the credit sales company enlarges one-sidedly. That is, from the standpoint of the credit sales company, the credit limit that is established by the company is one-sidedly canceled and the risk of a loss when a customer is insolvent one-sidedly increases.

Further, in the system of the publication, a dealing regulation using the credit limit can be completely removed by an operation at the side of the member store. This enables an extremely expensive dealing. Further, since the deregulation will be judged subjectively by an operator of the member store, if an operator removes the dealing regulation for an improper customer intentionally or by misjudgment, the credit sales company will suffer heavy losses when the customer will be insolvent.

### SUMMARY OF THE INVENTION

It is therefore an object of the present invention to provide a credit sales method or system, which is capable of permitting purchase of a commodity or service beyond a credit limit and is capable of preventing an one-sided increase in the risk of the credit sales company.

For the above object, according to the first aspect of the present invention, there is provided an improved credit sales method executed by a credit sales system, which includes:

a first decision step for deciding whether purchase history information of a customer satisfies a first credit balance increment condition that is determined by history with reference to a first storage for storing purchase history information for each customer of a member store;

a first calculation step for calculating a credit balance increment rate that defines risk borne by the member store corresponding to the first credit balance increment condition when the purchase history information is determined to satisfy the first credit balance increment condition at the first decision step; and

an output step for outputting that the payment by the credit card is approved when the requested payment price is lower than the product of the credit balance by the credit balance increment rate calculated at the first calculation step even if the requested payment price is higher than the credit balance.

Further, according to the second aspect of the present invention, there is provided an improved credit sales method executed by a credit sales system, which includes:

a second decision step for deciding whether sales promotion information of a commodity satisfies a second credit balance increment condition that is determined by the commodity with reference to a second storage for storing sales promotion information for each commodity in a member store;

a second calculation step for calculating a credit balance increment rate that defines risk borne by the member store corresponding to the second credit balance increment condition when the sales promotion information of the commodity is determined to satisfy the second credit balance increment condition at the second decision step; and

an output step for outputting that the payment by the credit card is approved when the requested payment price is lower than the product of the credit balance by the credit balance increment rate calculated at the second calculation step even if the requested payment price is higher than the credit balance.

Still further, according to the third aspect of the present invention, there is provided an improved credit sales method executed by a credit sales system, which includes:

a first decision step for deciding whether purchase history information of a customer satisfies a first credit balance increment condition that is determined by history with reference to a first storage for storing purchase history information for each customer of a member store;

a first calculation step for calculating a credit balance increment rate that defines risk borne by the member store corresponding to the first credit balance increment condition when the purchase history information is determined to satisfy the first credit balance increment condition at the first decision step;

a second decision step for deciding whether sales promotion information of a commodity satisfies a second credit balance increment condition that is determined by the commodity with reference to a second storage for storing sales promotion information for each commodity in a member store;

a second calculation step for calculating a credit balance increment rate that defines risk borne by the member store corresponding to the second credit balance increment condition when the sales promotion information of the commodity is determined to satisfy the second credit balance increment condition at the second decision step; and

an output step for outputting that the payment by the credit card is approved when the requested payment price is lower than the product of the credit balance by the credit balance increment rate calculated at the first calculation step or is lower than the product of the credit balance by the credit balance increment rate calculated at the second calculation step even if the requested payment price is higher than the credit balance.

Yet further, according to the fourth aspect of the present invention, there is provided an improved credit sales system, which includes:

a first storage for storing purchase history information for each customer of a member store;

a first decision device for deciding whether purchase history information of a customer satisfies a first credit balance increment condition that is determined by history with reference to the first storage;

a first calculation device for calculating a credit balance increment rate that defines risk borne by the member store corresponding to the first credit balance increment condition when the first decision device determines that the purchase history information satisfies the first credit balance increment condition; and

an output device for outputting that the payment by the credit card is approved when the requested payment price is lower than the product of the credit balance by the credit balance increment rate calculated by the first calculation device even if the requested payment price is higher than the credit balance.

Further, according to the fifth aspect of the present invention, there is provided an improved credit sales system, which includes:

a second storage for storing sales promotion information for each commodity in a member store;

a second decision device for deciding whether sales promotion information of a commodity satisfies a second credit balance increment condition that is determined by the commodity with reference to the second storage;

a second calculation device for calculating a credit balance increment rate that defines risk borne by the member store corresponding to the second credit balance increment condition when the second decision device determines that the sales promotion information of the commodity satisfies the second credit balance increment condition; and

an output device for outputting that the payment by the credit card is approved when the requested payment price is lower than the product of the credit balance by the credit balance increment rate calculated by the second calculation device even if the requested payment price is higher than the credit balance.

According to the present invention, since a customer using a credit card can purchase a commodity whose price is higher than a credit limit established by a credit sales company, the scale-up of the sales of both a credit sales company and a member store can be expected, which will enlarge the credit card business. Further, when the member store increases the credit limit on its responsibility (risk), since the member store bears a risk of the increased part, the risk of the credit sales company does not increase one-sidedly.

In general, while a credit sales company establishes a credit limit based on a customer's income, purchase history and payment history, the establishment must become standardized. On the other hand, a member store is able to know a detail situation about a customer because a member store directly contacts a customer. Therefore, the system of the present invention relegates the establishment of the increment rate of the credit balance to a member store, which enables more detailed service. Further, when the member store increases the credit balance on its responsibility, since the member store bears a risk of the increased part, the store decides carefully, which prevents increasing the credit balance for an improper customer. Still further, while the member store can increase the credit balance, it cannot cancel the credit limit. Therefore, even if the store increases the credit balance, the customer cannot purchase a commodity whose price is extremely higher than the credit limit. This prevents suffering heavy losses when the customer will be insolvent.

In addition, a member store preferably establishes the credit balance increment rate within a range that is defined in consultation with a credit sales company.

### DESCRIPTION OF THE ACCOMPANYING DRAWINGS

FIG. 1 is a block diagram showing an outline of a credit sales system of an embodiment according to the present invention;

FIG. 2 shows an example of a customer's credit information table in the credit sales system of the embodiment;

FIG. 3 shows an example of a customer's credit history information table in the credit sales system of the embodiment;

FIG. 4 shows an example of a member store's sales history information table in the credit sales system of the embodiment;

FIG. 5 shows an example of a member store's promoting commodity information table in the credit sales system of the embodiment;

FIG. 6 is a flowchart showing an outline of a process of the credit sales system of the embodiment;

FIG. 7 is a flowchart showing a detail of a customer's credit amount calculating process of the credit sales system of the embodiment; and

FIG. 8 is a flowchart showing a detail of a process for calculating a credit balance increment rate of the credit sales system of the embodiment.

### DESCRIPTION OF THE PREFERRED EMBODIMENTS

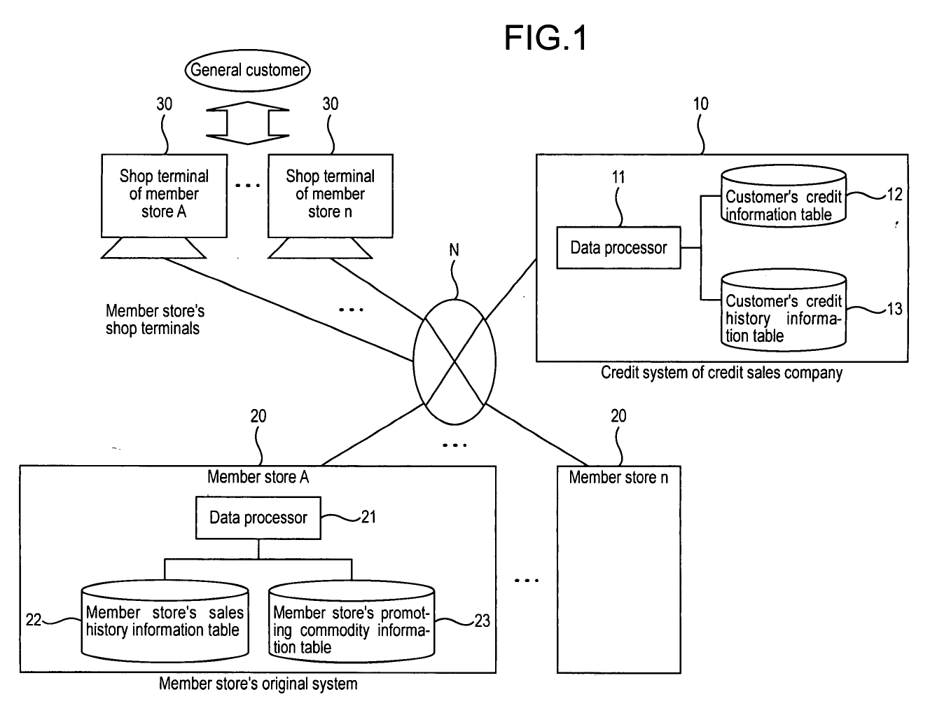

Hereinafter, a credit sales system of an embodiment according to the present invention will be described with reference to the drawings. First, an outline of the credit sales system will be described according to FIG. 1. FIG. 1 is a block diagram showing an outline of the credit sales system according to the embodiment.

As shown in FIG. 1, a credit system 10 of a credit sales company includes a data processor 11 as a central unit, a customer's credit information table 12 for managing a credit history of each customer, and a customer's credit history information table 13 for managing a credit limit that is established by the company itself and a credit balance corresponding to a purchase history. The credit system 10 of the company is connected to member store's original systems 20 and member store's shop terminals 30 of member stores A, B, . . . , n through a network N such as the Internet. The member stores A, B, . . . , n can sell commodities on credit using a credit card to a general customer through the use of the member store's shop terminal 30.

The member store's original system 20 includes a data processor 21 as a central unit, a member store's sales history information table 22 for managing a sales history and customer information in the member store for each customer, and a member store's promoting commodity information table 23 for managing which commodities are promoted for sales in the member store. The member store's original system 20 is connected to the credit system 10 of the credit sales company and the member store's shop terminals 30 through the network N.

The member store's shop terminals 30, which are known as POS terminals or register terminals, are installed in shops of the member stores and are connected to the credit system 10 of the credit sales company and the member store's original systems 20 through the network N.

The network N is a communication network that intermediates data transmissions among the credit system 10 of the credit sales company, the member store's original systems 20 and the member store's shop terminals 30. The network N transmits the data through a wired connection or a wireless connection.

In the above-described system, when one customer purchases a commodity using a credit card at the shop of the member store A, the shop terminal 30 of the member store A reads the credit card and sends card-payment request information to the credit system 10 of the credit sales company. The card-payment request information includes a credit ID recorded in the credit card, a requested payment price input at the member store, and a credit balance increment rate (default value is “1”) input at the member store. Receiving the card-payment request information, the data processor 11 of the credit system 10 of the credit sales company retrieves the credit balance of the customer from the customer's credit information table 12 using the credit ID as a search key. Then, the data processor 11 compares the requested payment price with the retrieved credit balance. When the requested payment price is lower than the credit balance, the data processor 11 updates the customer's credit history information table 13 and the customer's credit information table 12, and sends a reply for informing that the payment by card was approved to the member store's shop terminal 30. Further, the data processor 11 finds a possible credit amount that is the product of the credit balance by the credit balance increment rate. Even if the requested payment price exceeds the credit balance, when the requested payment price is lower than the possible credit amount, the data processor 11 updates the customer's credit history information table 13 and the customer's credit information table 12, and sends a reply for informing that the payment by card was approved to the member store's shop terminal 30. On the other hand, if the requested payment price exceeds the possible credit amount, the data processor 11 sends a reply for informing insufficient funds to the member store's shop terminal 30.

Receiving the information of the card-payment approval from the credit system 10 of the credit sales company, the member store's shop terminal 30 approves the dealing after processes such as a signature by the customer. Then, a salesperson of the member shop provides the commodity to the customer. On the other hand, when insufficient funds are informed, the member store's shop terminal 30 checks whether the credit balance increment rate has been calculated or not. If the rate has not been calculated, the member store's shop terminal 30 sends the request information for calculating credit balance increment including the customer ID and the commodity ID to the member store's original system 20. Receiving the request information for calculating credit balance increment, the data processor 21 of the member store's original system 20 retrieves the corresponding sales history from the member store's sales history information table 22 using the customer ID as a search key. Then, the data processor 21 decides whether the sales record of the customer satisfies a first credit balance increment condition that is determined by history. When the first credit balance increment condition is satisfied, the data processor 21 increases the credit balance increment rate. Further, the data processor 21 retrieves the corresponding commodity information from the member store's promoting commodity information table 23 using the commodity ID as a search key. The data processor 21 decides whether the commodity is a promoted commodity or not (whether the commodity satisfies the second credit balance increment condition that is determined by the commodity or not). If the commodity is a promoted commodity, the data processor 21 increases the credit balance increment rate. The member store must establish the credit balance increment rates by the history conditions and the commodity conditions before dealings. Further, when the credit balance increment rates are established by the member store's original system 20 based on the decisions of the member store side that are different from the decisions of the credit sales company, the member store bears the risks of the increased portions. That is, when the customer will be insolvent, the credit sales company bears losses of money within the credit limit that is originally established by the credit sales company and the increased portion established by the credit system 10 of the credit sales company, while the member store bears losses corresponding to the increased portion established by the member store's original system 20.

After finishing the calculations, the credit balance increment rate, which is a result of the credit balance increment calculation, is sent back to the member store's shop terminal 30. Receiving the credit balance increment rate, the member store's shop terminal 30 re-sends the card-payment request information including the received credit balance increment rate to the credit system 10 of the credit sales company. When the request information is received, the credit system 10 of the credit sales company calculates the possible credit amount using the credit balance increment rate, and compares the requested payment price with the possible credit amount to decide whether the credit dealing is available.

Next, the details of the above-described tables will be described.

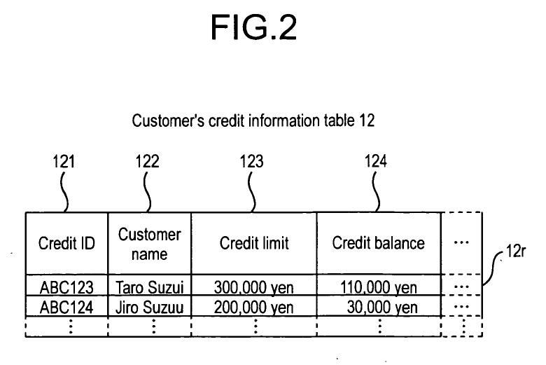

FIG. 2 shows an example of the customer's credit information table 12. The customer's credit information table 12 consists of customer's credit information records (12r) each of which includes a “credit ID” field (121) for storing an ID to uniquely identify a customer's credit card, a “member name” field (122) for storing a customer's name, a “credit limit” field (123) for storing a credit limit that is established by the credit sales company, a “credit balance” field (124) for storing a available balance that is a difference subtracting an unsettled used amount from the credit limit. The first customer's credit information record 12r in the customer's credit information table 12 of FIG. 2 stores “ABC123” in the credit ID field 121, “Taro Suzui” in the member name field 122, “ [symbol] 300,000” in the credit limit field 123 and “ [symbol] 110,000” in the credit balance field.

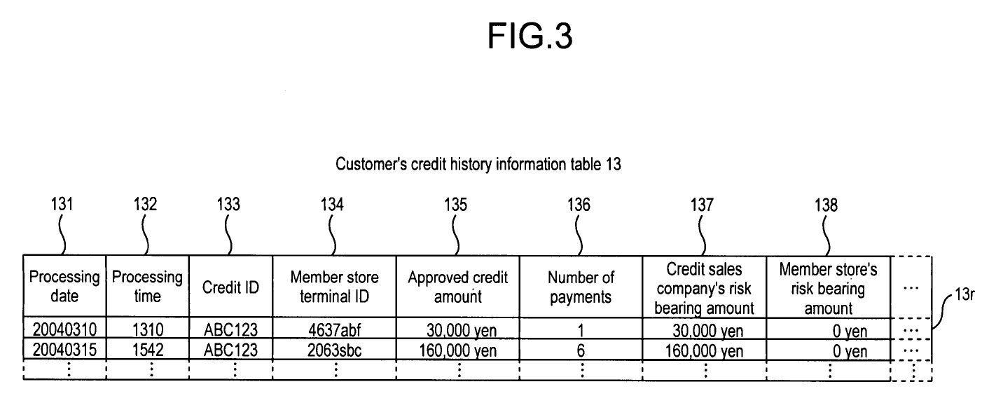

FIG. 3 shows an example of the customer's credit history information table 13. The customer's credit history information table 13 consists of customer's credit history information records each of which includes a “processing date” field (131) for storing a processing date, a “processing time” field (132) for storing a processing time, a “credit ID” field (133) for storing the credit ID that is the same as that in the customer's credit information table 12, a “member store terminal ID” field (134) for storing a member store's shop terminal ID to uniquely identify the member store's shop terminal processed, an “approved credit amount” field (135) for storing an approved credit amount, a “number of payments” field (136) for storing a number of payments, a “credit sales company's risk bearing amount” field (137) for storing the credit sales company's risk bearing amount that is a portion of the approved credit amount borne by the credit sales company, and a “member store's risk bearing amount” field (138) for storing a member store's risk bearing amount that is a portion of the approved credit amount borne by the member store. The first customer's credit history information record 13r in the customer's credit history information table 13 of FIG. 3 stores “20040310” in the processing date field 131, “1310” in the processing time field 132, “ABC123” in the credit ID field 133, “4637abf” in the member store terminal ID field 134, “ [symbol] 30,000” in the approved credit amount field 135, “1” in the number of payments field 136, “ [symbol] 30,000” in the credit sales company's risk bearing amount field 137 and “ [symbol] 0” in the member store's risk bearing amount field 138.

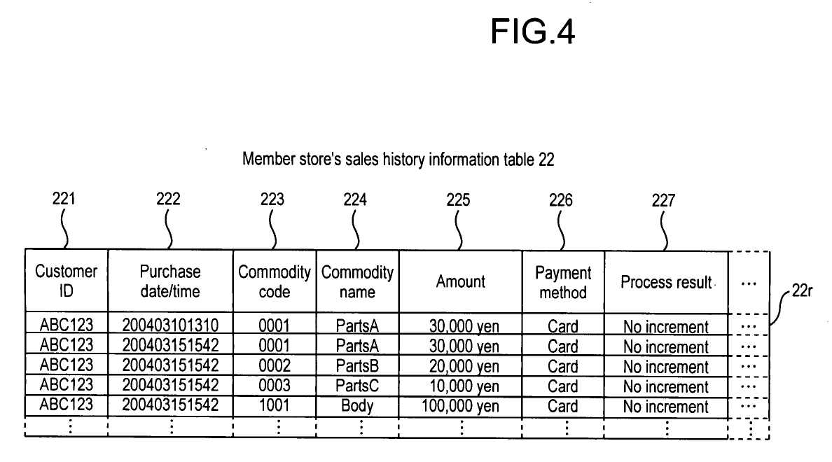

FIG. 4 shows an example of the member store's sales history information table 22. The member store's sales history information table 22 consists of member store's sales history information records 22r each of which includes a “customer ID” field (221) for storing an ID to uniquely identify a customer in a member store, a “purchase date/time” field (222) for storing purchase date and time, a “commodity code” field (223) for storing a commodity code of a purchased commodity, a “commodity name” field (224) for storing a commodity name of a purchased commodity and an “amount” field (225) for storing a purchase price, a “payment method” field (226) for storing a payment method such as card or cash, and a “process result” field (227) for storing a result of the process. The first member store's sales history information record 22r in the member store's sales history information table 22 of FIG. 4 stores “ABC123” in the customer ID field 221, “200403101310” in the purchase date/time field 222, “0001” in the commodity code field 223, “parts A” in the commodity name field 224 and “ [symbol] 30,000” in the amount field 225.

In addition, the first member store's sales history information record 22r in the member store's sales history information table 22 of FIG. 4 corresponds to the first customer's credit history information record 13r in the customer's credit history information table 13 of FIG. 3. Further, the member store's sales history information record 22r on the second line in the table 22 of FIG. 4 corresponds to customer's credit history information record 13r on the second line in the table 13 of FIG. 3. In the embodiment, one member store's sales history information record 22r is created for each commodity, while various modifications are available. For example, one record may include a plurality of the commodity code fields, the commodity name fields, the amount fields and one total amount field. In such a case, a set of the commodity code field, the commodity name field and the amount field is stored by the purchase date/time for each customer ID and a plurality of sets are sequentially stored in a record.

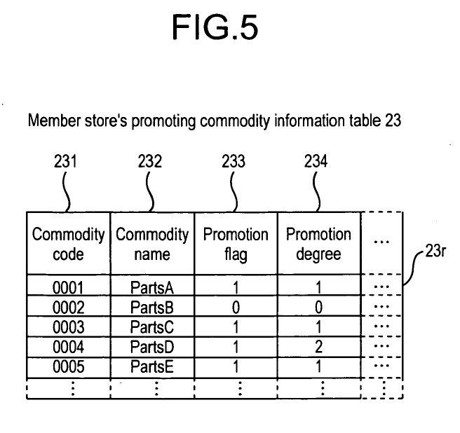

FIG. 5 shows an example of the member store's promoting commodity information table 23. The member store's promoting commodity information table 23 consists of promoted commodity records 23r each of which includes a “commodity code” field (231) for storing the commodity code to identify a commodity, a “commodity name” field (232) for storing a commodity name, a“promotion flag” field (233) for storing a promotion flag, a “promotion degree” field (234) for storing a promotion degree. The first promoted commodity record 23r in the member store's promoting commodity information table 23 of FIG. 5 stores “0001” in the commodity code field 231, “parts A” in the commodity name field 232, “1” in the promotion flag field 233 and “1” in the promotion degree field 234.

The values in the promotion flag field 233 and the promotion degree field 234 are set according to the degree of promotion of the commodity. If the member store wants to sell the commodity by all means, the promotion flag field 233 is set as “1”. If not so, the promotion flag field 233 is set as “0”. Further, the degree of promotion “0”, “1” or “2” is set in the promotion degree field 234. In the embodiment, when the promotion flag field 233 is “0”, the promotion degree is also “0”. When the promotion flag field 233 is “1”, the promotion degree is “1” or “2”. The promotion degree “2” represents the member store gives the commodity a push rather than the commodity whose promotion degree is “1”. As described below, the larger the promotion degree is, the larger the credit balance increment rate is. That is, an increased credit balance becomes larger for a commodity whose promotion degree is larger. Therefore, for two commodities having the same price, even if a payment by card for one commodity whose promotion degree is lower cannot be approved, a payment by card for the other commodity whose promotion degree is higher can be approved. Since the risk of the member store increases as the credit balance increment rate becomes larger, the member store is required to bear the increased risk when the member store establishes a large promotion degree. The member store must create the member store's promoting commodity information table 23 as needed before it applies to the credit sales system.

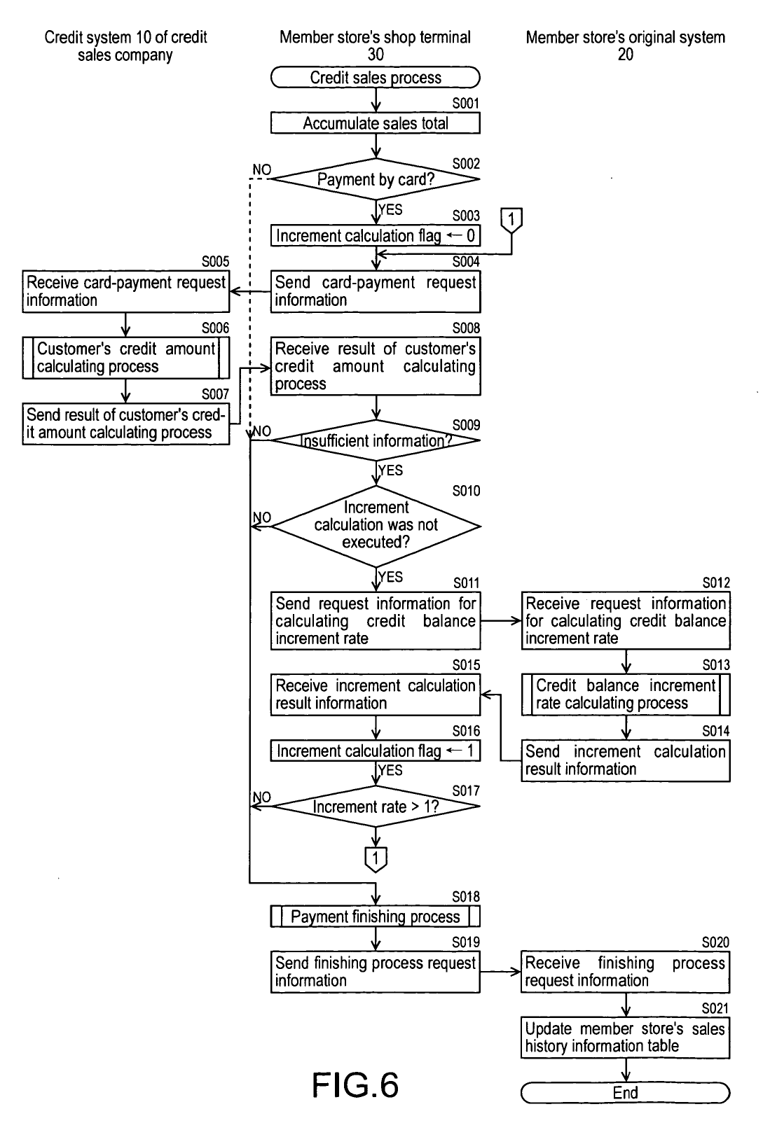

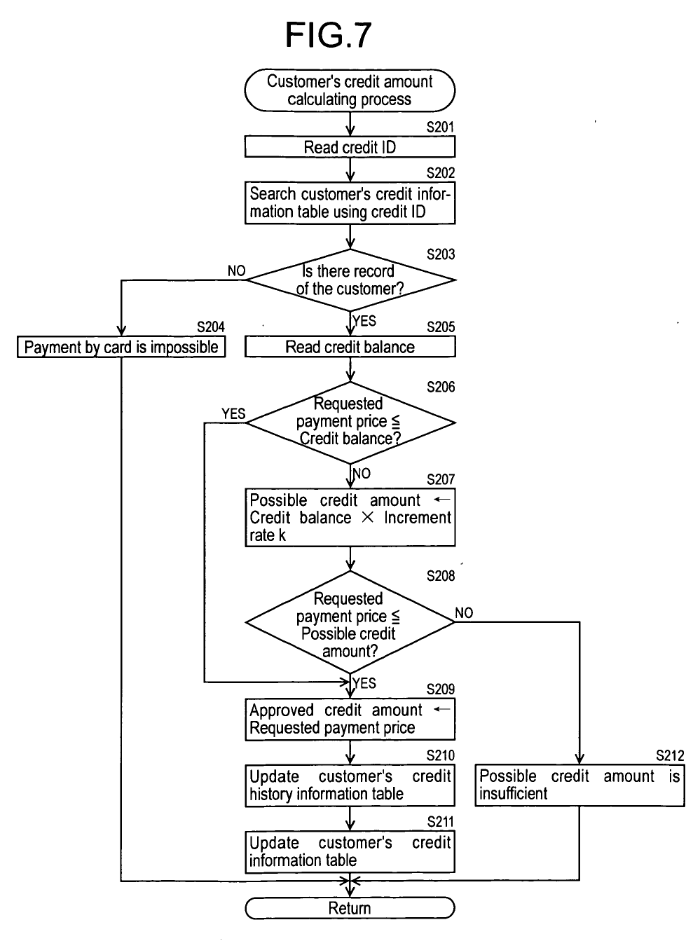

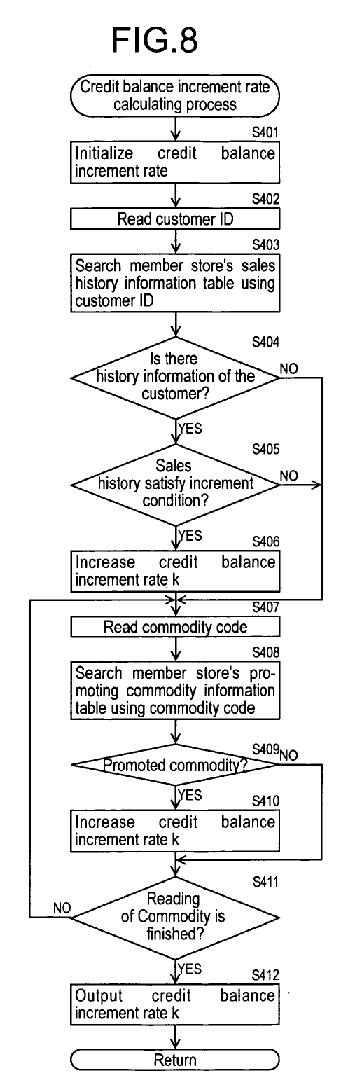

Next, the process of the credit sales system according to the embodiment will be described with reference to FIG. 6 through FIG. 8. FIG. 6 is a flowchart showing an outline of a process of the credit sales system, FIG. 7 is a flowchart showing a detail of a customer's credit amount calculating process executed by the credit system 10 of the credit sales company, FIG. 8 is a flowchart showing a detail of a process for calculating a credit balance increment rate executed by the member store's original system.

When the general customer shown in FIG. 1 purchases commodities, the general customer shows desired commodities to a salesperson who operates t/he member store's shop terminal 30. With this opportunity, the member store's shop terminal 30 reads the commodity ID of the commodities that are shown by the general customer and the terminal 30 retrieves the information about the desired commodities from a commodity information table (not shown) that stores commodity information such as a commodity ID, a commodity name, a unit price or the like. Then, the terminal 30 executes a process to accumulate sales total (S001). When the general customer requires payment by credit after finishing the sales total accumulation process for all the desired commodities, a salesperson reads the credit card by the terminal 30. When the credit information including the credit ID, which uniquely identifies the credit card, and number of payments is input to the terminal 30, the terminal 30 determines that the customer pays by a credit card (S002, Yes). Then, the terminal 30 sets the increment calculation flag as “0” (S003) and sends card-payment request information, which includes the requested payment price (the accumulated price), the member store's shop terminal ID to uniquely identify the member store's shop terminal 30, the credit ID, the number of payments, and a credit balance increment rate k whose default value is “1”, to the credit system 10 of the credit sales company through the network N (S004). When the general customer requires payment by cash (S002, No), the process goes to S018 described below.

Receiving the card-payment request information from the member store's shop terminal 30 through the network N (S005), the data processor 11 of the credit system 10 of the credit sales company executes a customer's credit amount calculating process described in FIG. 7 (S006).

The customer's credit amount calculating process at S006 will be described with reference to FIG. 7. The data processor 11 of the credit system 10 of the credit sales company reads the credit ID included in the card-payment request information received from the member store's shop terminal 30 through the network N (S201) and searches the customer's credit information table 12 using the credit ID as a search key (S202). As a result of the search at S202, the data processor 11 determines whether the customer's credit information record 12r corresponding to the credit ID was retrieved or not (S203). If the corresponding customer's credit information record 12r was not retrieved, the data processor 11 outputs that the payment by card is impossible as a result of the customer's credit amount calculating process (S204) and finishes the customer's credit amount calculating process.

When the customer's credit information record 12r was retrieved, the data processor 11 reads a value in the credit balance field 124 in the retrieved record 12r (S205) and compares it with the requested payment price included in the card-payment request information to determine whether the requested payment price is lower than the credit balance (S206). When the data processor 11 determines that the requested payment price is not lower than the credit balance (exceeds the credit balance) at S206, the data processor 11 calculates a possible credit amount that is a product of the value in the credit balance field 124 by the credit balance increment rate k included in the card-payment request information (S207), and compares the calculated possible credit amount with the requested payment price to determine whether the requested payment price is lower than the possible credit amount (S208).

When the data processor 11 determines that the requested payment price is lower than the credit balance at S206 or is lower than the possible credit amount at S208, the data processor 11 sets the requested payment price as the approved credit amount and outputs it as a result of the customer's credit amount calculating process (S209) Then, the data processor 11 creates a new customer's credit history information record where the current date is stored in the processing date field 131, the current time is stored in the processing time field 132, the credit ID is stored in the credit ID field 133, the member store terminal ID included in the card-payment request information is stored in the member store terminal ID field 134, the number of payments included in the card-payment request information is stored in the number of payments field 136, the amount that is satisfied by the credit balance in the requested payment price is stored in the credit sales company's risk bearing amount field 137, and the amount that is not satisfied by the credit balance in the requested payment price is stored in the member store's risk bearing amount field 138. The data processor 11 updates the customer's credit history information table 13 by adding a new created customer's credit history information record 13r (S210) Further, the processor 11 updates the customer's credit information table 12 to overwrite the existing value in the credit balance field 124 of the customer's credit information record 12r with the difference that is calculated by subtracting the value in the credit sales company's risk bearing amount field 137 set at S210 from the value in the credit balance field 124 retrieved at S204 (S211), and finishes the customer's credit amount calculating process. On the other hand, when the data processor 11 determines that the requested payment price is not lower than the possible credit amount (exceeds the possible credit amount) at S208, the data processor 11 outputs that the possible credit amount is insufficient as a result of the customer's credit amount calculating process (S212), and finishes the customer's credit amount calculating process.

Finishing the above described customer's credit amount calculating process, the data processor 11 of the credit system 10 of the credit sales company returns the process to FIG. 6 and sends the result of the customer's credit amount calculating process to the member store's shop terminal 30 through the network N (S007).

Receiving the result of the customer's credit amount calculating process from the credit system 10 of the credit sales company through the network N (S008), the member store's shop terminal 30 determines whether the result informs the insufficient possible credit amount of the customer (S009). When the result informs the insufficient possible credit amount and the increment calculation flag is “0”, the terminal 30 determines that the credit balance increment calculation has not been executed (S010). In such a case, the terminal 30 sends request information for calculating credit balance increment rate, which includes the customer ID and the commodity ID, to the member store's original system 20 through the network N (S011). At S010, the terminal determines that the credit balance increment calculation has been executed when the increment calculation flag is not “0”. When the terminal 30 determines that the result does not informs the insufficient possible credit amount of the customer at S009 or that the credit balance increment calculation has been executed at S010, the terminal 30 proceeds the process to S018.

When the data processor 21 of the member store's original system 20 receives the request information for calculating credit balance increment rate from the member store's shop terminal 30 through the network N (S012), it executes a credit balance increment rate calculating process described in FIG. 8 (S013).

Details of the credit balance increment rate calculating process at S013 will be described with reference to FIG. 8. The data processor 21 of the member store's original system 20 initializes the credit balance increment rate k to be 1.00 (S401). “k=1.00” means that the credit limit established by the credit sales company is used as-is, that is, the member store does not increase the credit balance.

Next, the data processor 21 reads the customer ID included in the request information for calculating credit balance increment rate received from the member store's shop terminal 30 through the network N (S402). The customer ID is information for uniquely identifying a customer in the member store. While the customer ID may be identical to the credit ID managed by the credit sales company, it is preferable that the customer ID is an original ID established by the member store in response to the credit ID to retain security of the credit card.

Next, the data processor 21 searches the member store's sales history information table 22 using the customer ID read at S402 as a search key (S403). The data processor 21 determines whether the member store's sales history information record 22r corresponding to the customer ID was retrieved by the search at S403 or not (S404). If no member store's sales history information record 22r was retrieved, the process goes to S407.

When the member store's sales history information records 22r were retrieved at S404, the data processor 21 determines whether the sales history information records 22r satisfies the increment condition or not (S405) Specifically, the data processor 21 reads the values in the purchase date/time fields 222 and the amount fields 225 of the sales history information records 22r about the customer to determine whether the total amount of the values in the amount fields 225 of the sales history information records 22r whose value in the purchase date/time fields 222 fall in the last three months is higher than [symbol] 200,000 or not.

When the data processor 21 determines that the increment condition is satisfied at S405, the data processor 21 adds an increment value corresponding to the degree thereof to the credit balance increment rate k (S406) Specifically, when the data processor 21 determines that the customer has sales performance higher than [symbol] 200,000 in the last three months at S405, the increment value “0.05” is added to the credit balance increment rate k at S406.

When the data processor 21 determines that the increment condition is not satisfied at S405, the process skips S406 and goes to S407. In addition, the determining method of the increment condition at S405 and the calculating method of the rate k at S406 are examples. Various combinations of the increment conditions and the increment values are available based on the values in the respective fields of the member store's sales history information record 22r. For example, the data processor 21 may determine whether the total purchase amount in the predetermined term exceeds the predetermined amount or whether the number of purchases exceeds the predetermined number as the increment condition. The increment values may be set in stages.

Next, the data processor 21 reads one commodity ID included in the request information for calculating credit balance increment rate (S407) and searches the member store's promoting commodity information table for the promoted commodity record 23r using the commodity code as a search key (S408). Then, the data processor 21 determines whether the commodity is a promoted commodity or not (S409). When the commodity is a promoted commodity, the data processor 21 adds an increment value to the credit balance increment rate k (S410). Specifically, when the value in the promotion flag field 233 is “1”, the data processor 21 determines that the commodity is a promoted commodity at S409 and adds the product of the value in the promotion degree field 234 by 0.15 as the increment value to the credit balance increment rate k at S410.

When the data processor 21 determines that the commodity is not a promoted commodity at S409, the process skips S410 and goes to S411. In the embodiment, the system includes the member store's promoting commodity information table 23. However, the promotion flag field 233 and the promotion degree field 234 may be established in an existing commodity information table that is generally used in the respective member stores to execute the process similar to the embodiment. Further, the determining method of the promoted commodity at S409 and the calculating method of the increment value at S410 are examples. Various combinations of the increment conditions and the increment values are available based on the values in the respective fields of the member store's promoting commodity information table 23. For example, the data processor 21 may determine whether the commodity is a promoted commodity based on the value in the promotion degree field 234 without using the value of the promotion flag. The increment values may be set in stages. Further, the increment value may be directly added to the credit balance increment rate k or the credit balance increment rate k may be increased for the commodities constituting predetermined combinations.

Next, the data processor 21 determines whether the every commodity ID included in the request information for calculating credit balance increment rate has been read (S411). The processes from S407 through S410 are repeated until the end of reading. With the above described process, the credit balance increment rate k is calculated for each customer. The values of the credit balance increment rate k for the same customer may be different for different commodities. In the same manner, the values of the credit balance increment rate k for the same commodity may be different for the different customers. While the increment values for the credit balance increment rate k are separately calculated based on the customer's history information and the promoting commodity information in the above embodiment, one of the two increment values may be used. For example, the smaller increment value or the larger increment value between two increment values may be used. On the other hand, the conditions to increase the credit balance increment rate k may be a complex condition. In such a case, when the data processor 21 determines that the condition is satisfied at S405, the processes from S407 through S411 are executed. If the decision at S404 or S405 becomes false (No), the process goes to S412. When the data processor 21 determines that all the commodity ID's have been read at S411, the data processor 21 outputs the credit balance increment rate k as a calculation result (S412) and finishes the credit balance increment rate calculating process.

After finishing the credit balance increment rate calculating process, the data processor 21 of the member store's original system 20 returns the process to FIG. 6 and sends increment calculation result information including the credit balance increment rate k output at S412 to the member store's shop terminal 30 through the network N (S014).

Receiving the increment calculation result information from the member store's original system 20 through the network N (S015), the member store's shop terminal 30 sets the increment calculation flag as “1” (S016), and determines whether the credit balance increment rate k included in the increment calculation result information is larger than “1” (S017). If k is larger than “1”, the terminal 30 returns the process to S004, sets the accumulated amount as the requested payment price and sends the card-payment request information to the credit system of the credit sales company 10 through the network N. The card-payment request information includes the member store's shop terminal ID to uniquely identify the member store's shop terminal 30, the credit ID, the number of payments and the credit balance increment rate k in the increment calculation result information received at S015.

When the general customer does not require payment by card (S002, No), when the result does not inform the insufficient possible credit amount of the customer (S009, No), when the credit balance increment calculation has been executed (S010, No) or when the credit balance increment rate k is not larger than “1”, the member store's shop terminal 30 executes a payment finishing process (S018). Since the payment finishing process is not a subject matter of the present invention, the process is not shown in the drawings. When the customer does not pay by card (S002, No), the customer pays by cash or securities such as a gift certificate. In such a case, the member store's shop terminal 30 receives the payment price, calculates changes and prints out a cash-register receipt according to operations by a salesperson who operates the member store's shop terminal 30 in the payment finishing process. When the result informed at S009 is card disenable notification, the member store's shop terminal 30 outputs that the card is invalid in the payment finishing process. When the result informed at S009 is that the customer's possible credit amount is higher than the required payment amount, the member store's shop terminal 30 prints out a cash-register receipt and a card usage details in the payment finishing process. When the credit balance increment calculation has been executed (S010), or when the credit balance increment rate k is not larger than “1” (S017), the member store's shop terminal 30 outputs that the credit card cannot be used because of insufficient credit balance in the payment finishing process. When the credit card is invalid or the credit balance is insufficient, a customer may require to pay by cash or another credit card. In such a case, the terminal 30 repeats the processes from S002 for the other desired payment method.

Exiting the payment finishing process at S018, the member store's shop terminal 30 sends finishing process request information to the member store's original system 20 through the network N (S019). The finishing process request information includes the customer ID, the commodity ID, the commodity name, the amount, the payment method (by a card, cash or the like), and the process result that defines whether the credit balance was increased or not. Receiving the finishing process request information from the member store's shop terminal 30 through the network N (S020), the data processor 21 of the member store's original system 20 updates the member store's sales history information table 22 by adding a new member store's sales history information record 22r (S021). When the new member store's sales history information record 22r is created, the data processor 21 writes the current date and time into the purchase date/time field 222, and writes the customer ID, the commodity ID, the commodity name, the amount, the payment method and the process result into the customer ID field 221, the commodity code field 223, the commodity name field 224, the amount field 225, the payment method field 226 and the process result field 227, respectively.

In the above-described embodiment, when the customer's credit amount calculating process by the credit system 10 of the credit sales company results in an insufficient credit balance and the increment rate has not been calculated, the member store's original system calculates the credit balance increment rate. However, the order of the processes may be changed as long as it does not go out of scope of the invention. For example, the credit balance increment rate due to a commodity may be calculated by executing the processes from S407 through S411 in conjunction with reading of the commodity ID during the sales accumulating process at S001, and the credit balance increment rate due to the sales history may be calculated by executing the process from S402 through S406 at the time of reading the card at S002. In such a case, the increment calculation flag is set as “1” at S003, and the card-payment request including the credit balance increment rate is sent at S004.

Further, when the credit balance increment rate due to the sales history is calculated, a table that define increment values calculated based on the increment conditions by the respective customer ID with reference to the member store's sales history information table 22 may be prepared in advance and the table may be used in place of the member store's sales history information table 22. In such a case, if the previously prepared table has been sent to the credit system 10 of the credit sales company through the network N, the credit system 10 of the credit sales company can calculate the credit balance increment rate due to the sales history by executing the processes from S402 through S406.

What is claimed is:

1. A credit sales method executed by a credit sales system, including:
a first decision step for deciding whether purchase history information of a customer satisfies a first credit balance increment condition that is determined by history with reference to a first storage for storing purchase history information for each customer of a member store;
a first calculation step for calculating a credit balance increment rate that defines risk borne by said member store corresponding to said first credit balance increment condition when said purchase history information is determined to satisfy said first credit balance increment condition at said first decision step; and
an output step for outputting that the payment by the credit card is approved when said requested payment price is lower than the product of said credit balance by said credit balance increment rate calculated at said first calculation step even if said requested payment price is higher than said credit balance.

2. A credit sales method executed by a credit sales system, including:
a second decision step for deciding whether sales promotion information of a commodity satisfies a second credit balance increment condition that is determined by the commodity with reference to a second storage for storing sales promotion information for each commodity in a member store;
a second calculation step for calculating a credit balance increment rate that defines risk borne by said member store corresponding to said second credit balance increment condition when said sales promotion information of the commodity is determined to satisfy said second credit balance increment condition at said second decision step; and
an output step for outputting that the payment by the credit card is approved when said requested payment price is lower than the product of said credit balance by said credit balance increment rate calculated at said second calculation step even if said requested payment price is higher than said credit balance.

3. A credit sales method executed by a credit sales system, including:
a first decision step for deciding whether purchase history information of a customer satisfies a first credit balance increment condition that is determined by history with reference to a first storage for storing purchase history information for each customer of a member store;
a first calculation step for calculating a credit balance increment rate that defines risk borne by the member store corresponding to said first credit balance increment condition when said purchase history information is determined to satisfy said first credit balance increment condition at said first decision step;
a second decision step for deciding whether sales promotion information of a commodity satisfies a second credit balance increment condition that is determined by the commodity with reference to a second storage for storing sales promotion information for each commodity in a member store;
a second calculation step for calculating a credit balance increment rate that defines risk borne by the member store corresponding to said second credit balance increment condition when said sales promotion information of the commodity is determined to satisfy said second credit balance increment condition at said second decision step; and
an output step for outputting that the payment by the credit card is approved when said requested payment price is lower than the product of said credit balance by said credit balance increment rate calculated at said first calculation step or is lower than the product of said credit balance by said credit balance increment rate calculated at said second calculation step even if said requested payment price is higher than said credit balance.

4. A credit sales system, including:
a first storage for storing purchase history information for each customer of a member store;
a first decision device for deciding whether purchase history information of a customer satisfies a first credit balance increment condition that is determined by history with reference to said first storage;
a first calculation device for calculating a credit balance increment rate that defines risk borne by the member store corresponding to said first credit balance increment condition when said first decision device determines that said purchase history information satisfies said first credit balance increment condition; and
an output device for outputting that the payment by the credit card is approved when said requested payment price is lower than the product of said credit balance by said credit balance increment rate calculated by said first calculation device even if said requested payment price is higher than said credit balance.

5. A credit sales system, including:
a second storage for storing sales promotion information for each commodity in a member store;
a second decision device for deciding whether sales promotion information of a commodity satisfies a second credit balance increment condition that is determined by the commodity with reference to said second storage;
a second calculation device for calculating a credit balance increment rate that defines risk borne by the member store corresponding to said second credit balance increment condition when said second decision device determines that said sales promotion information of the commodity satisfies said second credit balance increment condition; and
an output device for outputting that the payment by the credit card is approved when said requested payment price is lower than the product of said credit balance by said credit balance increment rate calculated by said second calculation device even if said requested payment price is higher than said credit balance.

6. A credit sales system, including:
a first storage for storing purchase history information for each customer of a member store;
a first decision device for deciding whether purchase history information of a customer satisfies a first credit balance increment condition that is determined by history with reference to said first storage;
a first calculation device for calculating a credit balance increment rate that defines risk borne by the member store corresponding to said first credit balance increment condition when said first decision device determines that said purchase history information satisfies said first credit balance increment condition;
a second storage for storing sales promotion information for each commodity in a member store;
a second decision device for deciding whether sales promotion information of a commodity satisfies a second credit balance increment condition that is determined by the commodity with reference to said second storage;
a second calculation device for calculating a credit balance increment rate that defines risk borne by the member store corresponding to said second credit balance increment condition when said second decision device determines that said sales promotion information of the commodity satisfies said second credit balance increment condition; and
an output device for outputting that the payment by the credit card is approved when said requested payment price is lower than said product of said credit balance by said credit balance increment rate calculated by said first calculation device or is lower than the product of said credit balance by said credit balance increment rate calculated by said second calculation device even if said requested payment price is higher than said credit balance.

7. A credit sales program executed by a credit sales system, including:
a first decision step for deciding whether purchase history information of a customer satisfies a first credit balance increment condition that is determined by history with reference to a first storage for storing purchase history information for each customer of a member store;
a first calculation step for calculating a credit balance increment rate that defines risk borne by the member store corresponding to said first credit balance increment condition when said purchase history information is determined to satisfy said first credit balance increment condition at said first decision step; and
an output step for outputting that the payment by the credit card is approved when said requested payment price is lower than the product of said credit balance by said credit balance increment rate calculated at said first calculation step even if said requested payment price is higher than said credit balance.

8. A credit sales program executed by a credit sales system, including:
a second decision step for deciding whether sales promotion information of a commodity satisfies a second credit balance increment condition that is determined by the commodity with reference to a second storage for storing sales promotion information for each commodity in a member store;
a second calculation step for calculating a credit balance increment rate that defines risk borne by the member store corresponding to said second credit balance increment condition when said sales promotion information of the commodity is determined to satisfy said second credit balance increment condition at said second decision step; and
an output step for outputting that the payment by the credit card is approved when said requested payment price is lower than the product of said credit balance by said credit balance increment rate calculated at said second calculation step even if said requested payment price is higher than said credit balance.

9. A credit sales program executed by a credit sales system, including:
a first decision step for deciding whether purchase history information of a customer satisfies a first credit balance increment condition that is determined by history with reference to a first storage for storing purchase history information for each customer of a member store;
a first calculation step for calculating a credit balance increment rate that defines risk borne by the member store corresponding to said first credit balance increment condition when said purchase history information is determined to satisfy said first credit balance increment condition at said first decision step;
a second decision step for deciding whether sales promotion information of a commodity satisfies a second credit balance increment condition that is determined by the commodity with reference to a second storage for storing sales promotion information for each commodity in a member store;
a second calculation step for calculating a credit balance increment rate that defines risk borne by the member store corresponding to said second credit balance increment condition when said sales promotion information of the commodity is determined to satisfy said second credit balance increment condition at said second decision step; and
an output step for outputting that the payment by the credit card is approved when said requested payment price is lower than the product of said credit balance by said credit balance increment rate calculated at said first calculation step or is lower than the product of said credit balance by said credit balance increment rate calculated at said second calculation step even if said requested payment price is higher than said credit balance.
